(19) United States
(12) Patent Application Publication
(10) Pub. No.: US 2026/0355749 A1
(43) Pub. Date: Nov. 12, 2026

(54) LOW-VOLUME SHALLOW MICROWELL-BASED SPATIAL PROTEOMICS

(71) Applicant: Battelle Memorial Institute, Richland, WA (US)

(72) Inventors: Tujin Shi, Richland, WA (US); Zhangyang Xu, Richland, WA (US); Marsobyn Salalila, Richland, WA (US); Reta Birhanu Kitata, Richland, WA (US); Kai Zhang, Sugar Land, TX (US); Joon Hee Jang, Sugar Land, TX (US)

(21) Appl. No.: 19/661,843

(22) Filed: Apr. 29, 2026

Related U.S. Application Data
(60) Provisional application No. 63/800,744, filed on May 6, 2025.

(51) Int. Cl. B01L 3/00

(52) U.S. Cl. CPC B01L 3/5085; B01L 2200/12; B01L 2300/0829; B01L 2300/12

(57) ABSTRACT

96-well plates are used in a variety of technologies and are standard tools across multiple applications. For very small sample sizes, however, a conventional 96-well plate that matches uniform sizing can be inaccurate or unacceptable. The modified well plate disclosed herein addresses both interoperability and usability concerns.

### STATEMENT OF FEDERALLY SPONSORED RESEARCH OR DEVELOPMENT

This invention was made with government support under Contract No. DE-AC0576RL01830 awarded by the United States Department of Energy and grant numbers MH128885 and CA256967 awarded by the National Institute for Health. The government has certain rights in the invention.

### BACKGROUND

Proteomics refers to the comprehensive study and analysis of proteins, including their distribution, roles, and functions within biological processes, structures, and cellular pathways. This field encompasses the systematic identification and quantification of proteins across different spatial contexts, from individual cells to complex tissue structures.

Proteomic mapping, specifically spatial proteomics, focuses on understanding how proteins are spatially distributed and regulated within biological samples. This approach allows researchers to study protein localization and abundance patterns across different regions of tissues, providing crucial insights into cellular organization and function. Traditional proteomic mapping techniques have been limited by their ability to analyze only large sample volumes or their inability to maintain spatial resolution when processing tissue samples.

Conventional methods for proteomic mapping include antibody-based approaches such as cyclic immunofluorescence (cycIF), co-detection by indexing (CODEX), multiplexed ion beam imaging (MIBI), and imaging mass cytometry (IMC). These traditional techniques, while valuable, often face limitations in terms of the number of proteins that can be simultaneously analyzed and the availability of high-quality antibodies for target proteins of interest.

Standard 96-well plates are widely used tools in biological and analytical research, including in proteomics. Standard 96-well plates are shaped as a rectangular plate with a standardized array of 12 × 8 wells arranged with 9 mm spacing between well centers. These conventional plates are typically manufactured from polystyrene (PS) or polypropylene (PP) materials, with polystyrene being commonly used for applications not requiring heat treatment, while polypropylene plates are utilized for procedures involving heating or DMSO compatibility.

Traditional 96-well plates are designed for larger sample volumes, typically ranging from 150-200 microliters for standard plates to 40 microliters for 384-well variants. The wells in conventional plates are characterized by their significant depth, typically 11-13 millimeters, which creates challenges for microscopic examination of samples and precise handling of small-volume specimens.

The standard dimensions of these plates are precisely defined to ensure compatibility with automated laboratory equipment and thermal cyclers. The overall plate dimensions typically include a length of 127.76 ± 0.25 mm and a width of 85.48 ± 0.25 mm. This standardization allows for broad compatibility across different laboratory instruments and automated handling systems.

However, these conventional plates present significant limitations for applications requiring precise handling of small quantities or microscopic examination of samples. The large well volumes result in sample loss and reduced recovery efficiency, while the substantial well depth impedes direct microscopic observation of samples. These limitations make traditional 96-well plates particularly unsuitable for advanced analytical techniques such as spatial proteomics, where precise handling of small-volume samples and direct microscopic observation are essential.

Mass spectrometry-based approaches have emerged as powerful tools for proteomic analysis, offering advantages in terms of unbiased protein detection and quantification. However, existing platforms typically require larger sample volumes (or amounts) and are not suitable for maintaining spatial information during analysis. Current standard multi-well plates used in these applications are designed for larger sample volumes (or amounts), making them inefficient for applications requiring precise handling of small quantities, such as spatial proteomics and single-cell analysis.

### SUMMARY

The disclosure of the instant application provides a novel well plate design that enables high-precision spatial proteomics analysis through several innovative features and improvements. The well plate includes an array of shallow wells configured to facilitate collection and analysis of microscale tissue samples while maintaining compatibility with standard laboratory equipment.

In various embodiments, the well plate comprises wells having reduced depth compared to conventional designs, enabling direct microscopic examination of samples and improved collection efficiency. The wells may be formed from polypropylene material selected for a combination of features that can include temperature tolerance, a wide range of organic solvents, sample recovery, and reduced protein binding characteristics.

The well plate may include structural features such as raised rims around wells to enhance sealing performance, while maintaining standardized spacing and overall dimensions for compatibility with automated systems and existing laboratory equipment. The wells may be configured with geometries including specific opening and bottom diameters selected to minimize sample adhesion and facilitate precise sample handling.

Embodiments of the invention enable high-throughput collection and analysis of tissue samples at various scales, from single cells to larger voxels, while maintaining spatial information critical for proteome mapping applications. The well plate design supports automated collection protocols and is compatible with multiple tissue preparation methods including fresh frozen, OCT-embedded, and FFPE tissues.

The well plate may be used in conjunction with laser capture microdissection systems, thermal cyclers, and automated liquid handling equipment to enable efficient processing of small volume samples. The design facilitates reduced sample loss and improved recovery compared to conventional well plates while maintaining the ability to process multiple samples simultaneously.

Through integration of these various features, the invention provides a platform that addresses key limitations of existing well plate designs while enabling new capabilities in spatial proteomics and other applications requiring precise handling of small volume samples.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a front perspective view of a well plate according to one embodiment.

FIG. 2 is a front view of the well plate of FIG. 1, including a dashed line indicating a cross-section corresponding to FIG. 5;

FIG. 3 is a rear view of the well plate of FIG. 1;

FIG. 4 is a detailed partial view of the well plate of FIG. 1, showing a single well thereof in detail;

FIG. 5 is a cross-sectional view of the well plate of FIG. 1, taken across the line 5—5;

FIG. 6 is a detailed cross-sectional view of a single well of the well plate, as indicated at section 6 of FIG. 5;

FIG. 7 is a back view of an alternative embodiment of the well plate of FIGS. 1–6.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. It should be understood that this invention is not limited to the particular methodology, protocols, and reagents, etc., described herein and as such may vary. The following detailed description is therefore not to be taken in a limiting sense, and the scope of the present disclosure is defined by the appended claims and their equivalents.

Unless defined otherwise, all technical and scientific terms used herein have the same meaning as those commonly understood to one of ordinary skill in the art to which this invention pertains.

For the purposes of this application the following terms shall have the following meanings:

As used herein and in the claims, the singular forms “a,” “an”, and “the” include the plural reference unless the context clearly indicates otherwise.

The novel well plate design described herein represents a significant advancement over conventional plates through several integrated improvements that enable precise handling of small volume samples and enhanced microscopic examination. The design features a significantly reduced well depth, while using an aspect ratio between well height and diameter that prevents sample adhesion to well walls. The wells incorporate a U-shaped bottom design that enhances sample handling and heat distribution characteristics. The plate is manufactured from materials selected for superior temperature tolerance, enhanced sample recovery capabilities, low protein binding characteristics, and compatibility with a wide range of organic solvents (e.g., DMSO).

Additional improvements in structural features include a raised rim around the wells, which improves adhesive film sealing performance. The overall plate dimensions maintain compatibility with standard laboratory equipment, measuring 127.48 ± 0.02 mm in length and 85.26 ± 0.02 mm in width, with standardized well-to-well spacing of 8.98 ± 0.003 mm to ensure compatibility with automated systems. The design’s functionality is thus maintained for small sample testing such as direct microscopic examination of samples and laser capture microdissection tissue collection. The plate demonstrates improved heat transfer characteristics through reduced bottom thickness, while maintaining full compatibility with thermal cyclers and automated liquid handling systems. These integrated improvements collectively enable high-throughput collection and processing of small tissue samples while preserving compatibility with standard laboratory equipment.

Imaging and testing of small samples is facilitated by the design described herein, having a wide mouth facilitating voxel capture. The ability to analyze small sample sizes provides significant advantages for biological and analytical research applications. Small sample analysis enables higher spatial resolution and more precise examination of specific regions within tissues, allowing researchers to study localized variations in cellular composition and function. This increased precision in sample collection and analysis helps maintain spatial information that would otherwise be lost when processing larger tissue sections.

Working with small samples reduces sample consumption and waste, which is particularly important when dealing with precious or limited biological specimens. This efficiency in sample utilization enables multiple analyses from a single source, improving or increasing the information obtained from each specimen. Additionally, smaller sample sizes allow for more targeted analysis of specific cellular regions or structures, providing enhanced understanding of local biological processes and interactions.

The analysis of small samples facilitates higher throughput capabilities, as multiple discrete samples can be processed simultaneously while maintaining their individual spatial context. This approach enables comprehensive mapping of tissue regions through systematic analysis of numerous small sections, providing detailed insights into tissue organization and function. Small sample analysis also supports single-cell resolution studies, allowing examination of cellular heterogeneity and individual cell characteristics within complex tissue environments.

Furthermore, working with reduced sample volumes can improve analytical sensitivity by minimizing dilution effects and reducing interference from surrounding tissues. This enhanced sensitivity enables detection and quantification of low-abundance molecules that might be missed in larger sample volumes. The ability to precisely collect and analyze small samples also supports standardization and reproducibility in analytical procedures, as samples can be more consistently defined and processed.

In addition to small size, the well plates disclosed herein also include an improved shape. Specifically, the aspect ratio between well height and diameter plays an important role in improving sample handling and recovery in well plate designs. A balanced ratio helps prevent sample adhesion to well walls during both collection and processing steps, which is important in maintaining sample integrity and improved recovery.

The relationship between well height and diameter influences fluid dynamics within the well, affecting how samples interact with well surfaces during collection and processing. An appropriate choice of aspect ratio helps samples naturally settle at the well bottom rather than adhering to side walls, which can be particularly beneficial when working with small volume samples.

The well geometry created by this height-to-diameter relationship also impacts the efficiency of sample collection, particularly when using laser capture microdissection techniques. An appropriate aspect ratio supports efficient sample capture by providing adequate space for sample entry while maintaining precise positioning.

Furthermore, the height-to-diameter relationship affects the well’s thermal characteristics during heating and cooling cycles. Selection of an appropriate ratio helps promote uniform heat distribution throughout the sample volume while minimizing potential areas for sample loss or degradation.

The aspect ratio also influences the plate’s compatibility with microscopic examination, as the relationship between well height and diameter affects the ability to visualize samples throughout the well depth. This characteristic is helpful for applications where it is desirable to provide visual confirmation of sample placement and processing status.

Selection of materials with desirable surface energy can also aid in sample handling and recovery in well plate designs. Materials with low protein binding properties help prevent unwanted sample adhesion and loss during processing steps, which can be particularly useful when working with small volume biological samples.

Surface energy properties of the selected material influence how samples interact with well surfaces during collection and processing. Appropriate material selection maintains intact samples and renders them recoverable rather than binding to well surfaces.

The material’s compatibility with common solvents and reagents, such as DMSO, expands the range of possible applications and processing methods. This chemical compatibility, combined with appropriate surface energy characteristics, enables robust sample processing while minimizing unwanted interactions between samples and well surfaces.

Temperature tolerance of the selected material also affects sample processing capabilities, particularly during heating cycles. Materials that maintain their surface properties across a range of temperatures help ensure consistent sample behavior throughout various processing steps.

The material’s optical properties can also impact visualization capabilities, with appropriate materials allowing clear observation of samples during processing while maintaining their beneficial surface energy characteristics. This combination of properties supports both practical handling and analytical requirements.

The improvement of heat transfer characteristics (e.g., reduction in thermal resistivity) in well plate designs provides several important advantages for sample processing and analysis. Efficient heat transfer enables uniform temperature distribution throughout samples during thermal cycling steps for consistent and reliable sample processing.

The well geometry and bottom thickness significantly influence thermal conductivity and heat distribution patterns. Tuned heat transfer characteristics can be used to provide rapid and uniform temperature changes throughout the sample volume, which is particularly important when working with temperature-sensitive protocols or thermal cycling procedures. Enhanced thermal properties support improved sample processing efficiency by enabling faster heating and cooling cycles while maintaining temperature uniformity. This thermal efficiency is particularly important for applications where precise temperature control during sample preparation and analysis steps is important.

The combination of well geometry and thermal characteristics affects the plate’s compatibility with thermal cyclers and other temperature-controlled instruments. Proper heat transfer properties ensure consistent performance across different processing steps while maintaining sample integrity. Additionally, efficient heat transfer characteristics help minimize temperature gradients within wells, which can affect sample behavior and processing consistency. This uniformity can be particularly important when working with small volume samples where even minor temperature variations can impact analytical results.

The incorporation of standardized dimensions and structural rigidity in well plate designs provides essential benefits for laboratory applications and workflow integration. A rigid plate structure helps maintain precise well positioning and prevents warping or deformation during processing steps for maintaining compatibility with automated systems. Standardized dimensions enable seamless integration with existing laboratory equipment including thermal cyclers, automated liquid handlers, and laser capture microdissection systems. This compatibility with standard laboratory automation equipment allows the plate to be incorporated into established workflows without requiring specialized adaptations or modifications.

The plates described herein have a structural design that supports stacking capabilities for efficient storage and handling while maintaining plate integrity. This characteristic is particularly important for high-throughput applications where multiple plates need to be processed and stored. The combination of rigidity and standardized dimensions ensures consistent performance across different instruments and processing steps. This reliability is essential for maintaining reproducibility in analytical procedures and enabling integration with various laboratory automation platforms.

Furthermore, adherence to industry-standard dimensions allows the plate to be used with common laboratory accessories such as plate holders, sealing films, and storage systems. This compatibility with existing laboratory infrastructure supports practical implementation while maintaining the specialized capabilities of the design.

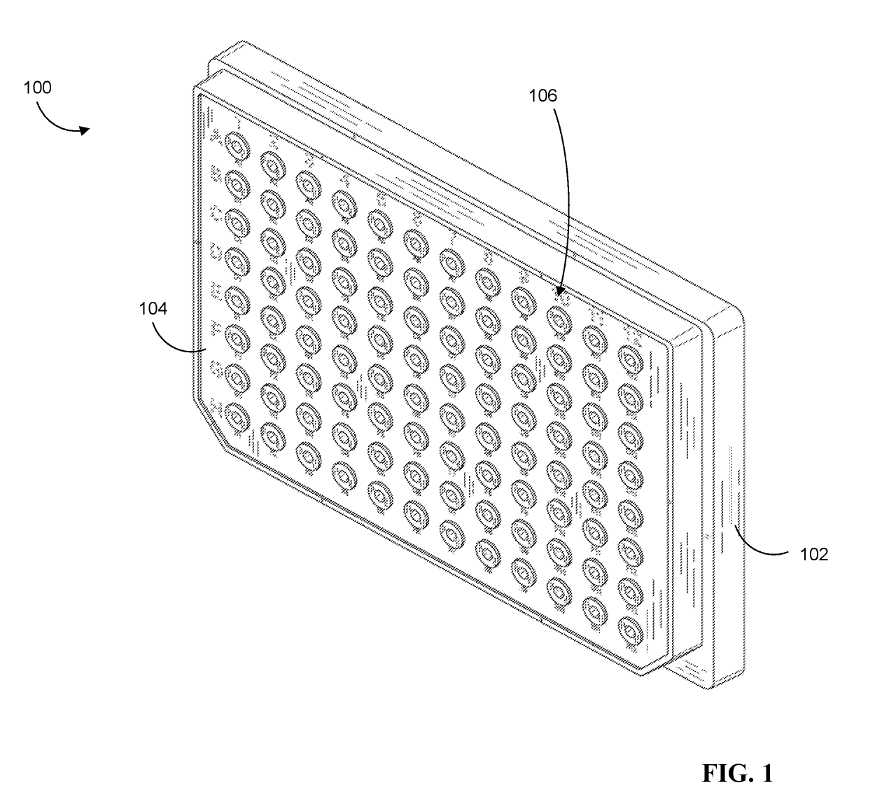

FIG. 1 illustrates a well plate 100 according to one embodiment of the present invention. The well plate 100 includes a base 102 having a top surface 104 with an array of wells 106 formed therein.

The wells 106 are arranged in a standardized 12 × 8 array configuration with uniform 9 mm spacing between well centers, maintaining compatibility with conventional laboratory automation equipment while providing enhanced capabilities for small volume sample analysis. Each well 106 extends downward from the top surface 104 of the base 102, creating a shallow sample containment structure that is advantageous for microscopic examination and sample recovery.

The wells 106 incorporate a specialized geometry featuring a wider opening that narrows toward the bottom, creating an advantageous aspect ratio between well height and diameter for the purposes described above. This configuration facilitates efficient sample capture during laser microdissection while minimizing sample adhesion to well walls during processing.

The well plate 100 operates by providing individual containment volumes for microscale tissue samples, enabling automated collection and processing while maintaining spatial information. The shallow well design allows direct microscopic examination of samples throughout the well depth, while the shallow well geometry also promotes efficient sample recovery and processing.

The importance of this design lies in its multiple integrated improvements over conventional well plates. The shallow well configuration enables direct microscopic examination while maintaining compatibility with standard laboratory equipment. The shallow well geometry enhances sample recovery by reducing adhesion, while the material selection provides superior temperature tolerance and chemical compatibility. The standardized dimensions ensure broad compatibility with existing laboratory automation systems, while the rigid construction maintains precise well positioning during processing.

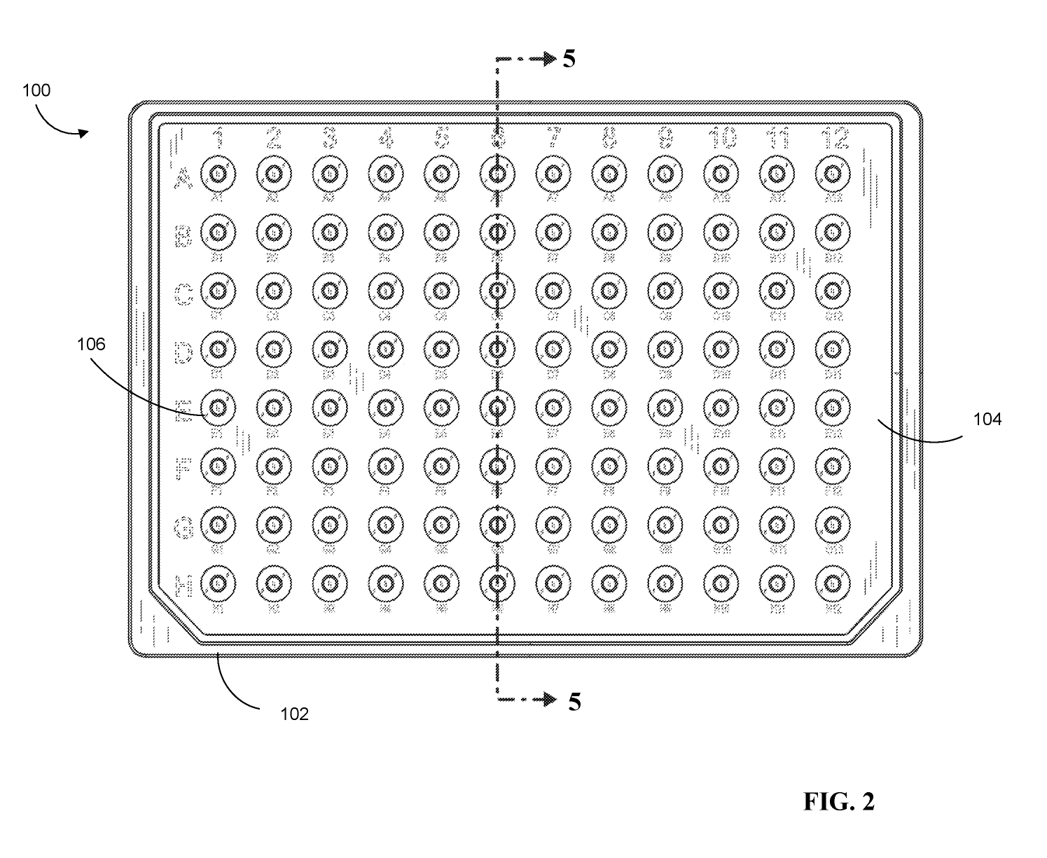

FIG. 2 illustrates a front view of the well plate 100, showing the arrangement and configuration of key structural elements. The view depicts the base 102 with its top surface 104 and the array of wells 106 arranged in a standardized pattern.

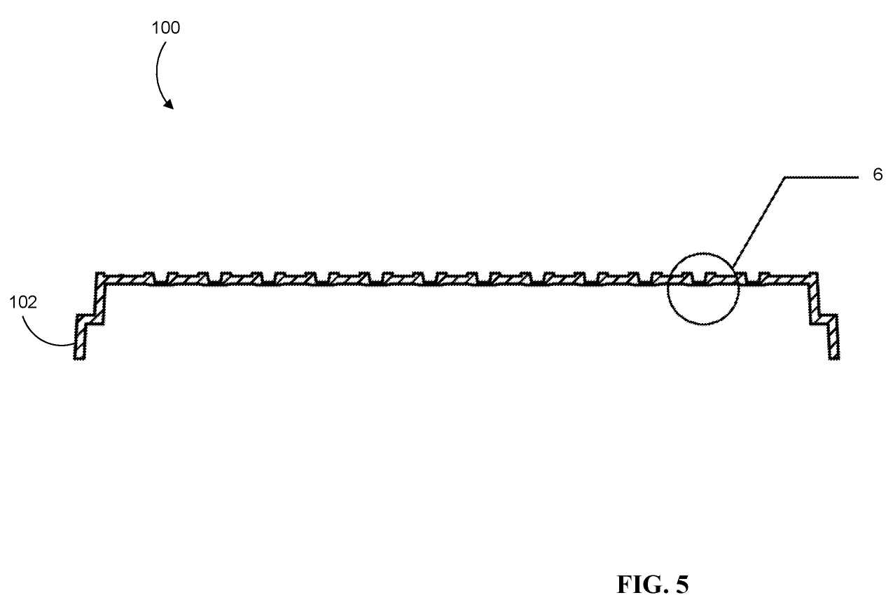

As described with respect to FIG. 1, the wells 106 are arranged in a precise 12 × 8 configuration, maintaining uniform 9 mm center-to-center spacing. The figure includes a dashed line indicating the location of a cross-sectional view that corresponds to FIG. 5, providing reference for understanding the plate’s internal structure.

The structural elements are arranged to create a rigid, unified assembly that maintains precise dimensional tolerances. The base 102 provides a stable foundation that supports the array of wells 106, while the top surface 104 is configured to facilitate sample collection and processing.

The well plate operates by providing a standardized platform for high-throughput sample collection and analysis. The precise arrangement of wells enables automated processing while maintaining consistent spacing and alignment for compatibility with laboratory automation equipment.

This configuration is particularly useful as it combines the benefits of standardized dimensions for broad equipment compatibility with a well geometry that provides improved sample handling. The precise arrangement of wells supports efficient sample collection and processing while maintaining the structural rigidity necessary for automated handling. The standardized layout ensures compatibility with existing laboratory equipment while incorporating the specialized features needed for small volume sample analysis.

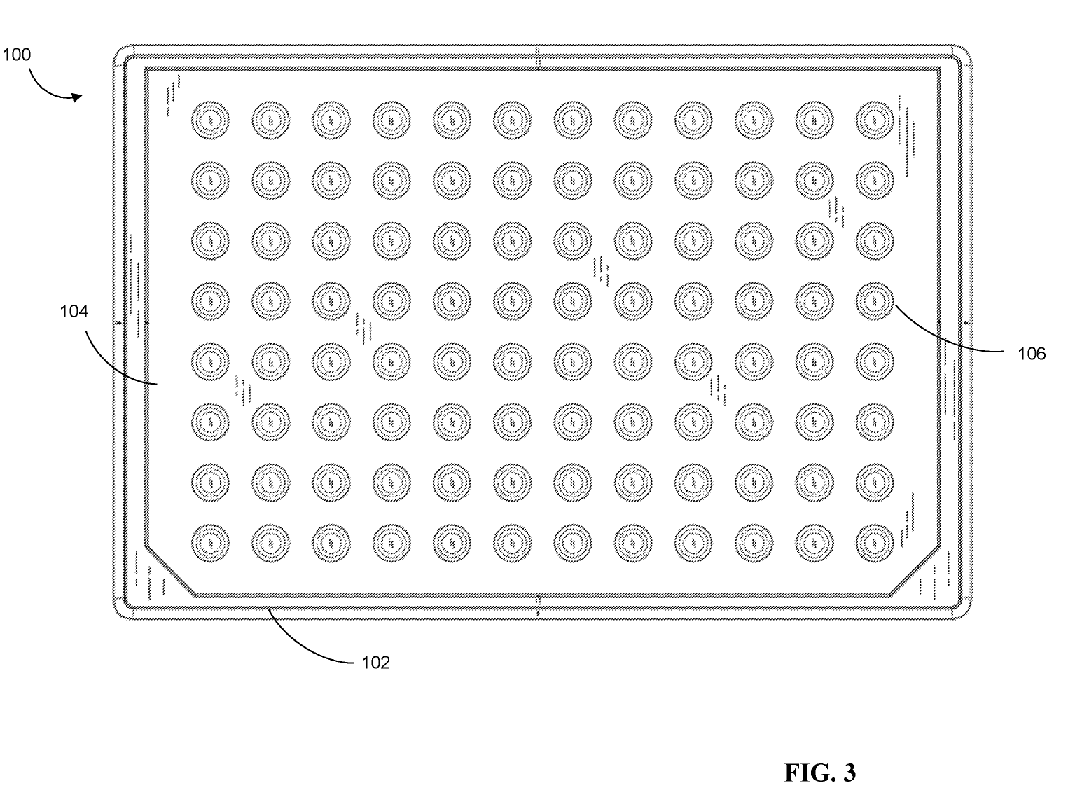

FIG. 3 illustrates a rear view of the well plate 100, showing the arrangement and configuration of wells 106 from the opposite perspective. This view provides additional detail about the structural arrangement and spatial relationships between plate components.

The wells 106 are arranged in the standardized 12 × 8 array configuration, maintaining consistent spacing and alignment throughout the plate structure. The rear view perspective highlights the uniform distribution of wells and their integration with the base structure. The structural elements are arranged to provide a desired level of rigidity while maintaining the precise dimensional tolerances for automated handling systems. The rear view demonstrates how the wells 106 are integrated into the base structure to form a unified assembly that maintains structural integrity during use.

The well plate operates by providing stable containment volumes that maintain consistent positioning and alignment during automated processing steps. The rear view configuration demonstrates how the plate maintains structural rigidity while incorporating features that enable efficient heat transfer and sample processing. This rear view perspective illustrates how the plate design achieves structural stability while incorporating specialized features for improved sample handling. The view demonstrates how the plate maintains compatibility with automated systems while providing the specialized capabilities needed for small volume sample analysis. Additionally, the rear view shows how the design enables efficient stacking for storage while preserving structural integrity.

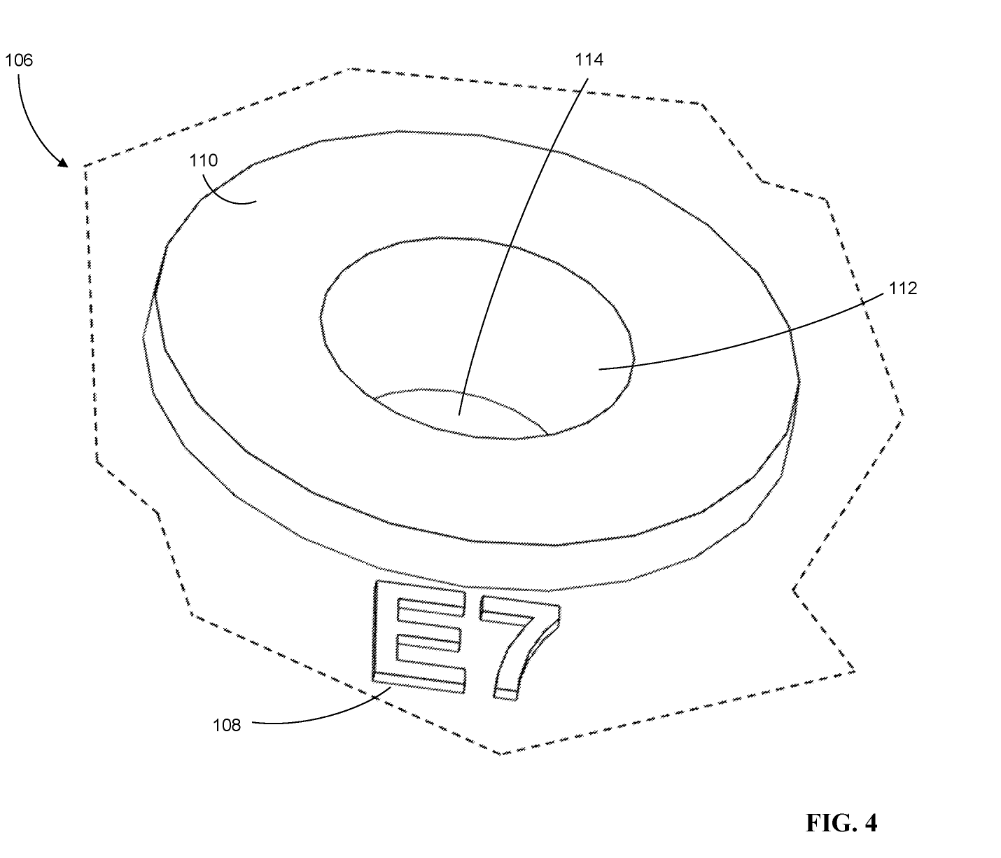

FIG. 4 provides a detailed partial view of the well plate 100, specifically highlighting a single well 106 to illustrate key structural features. The figure shows the well’s integration with an indicium 108, a lip 110, a wall 112, and a bottom 114, demonstrating the relationships between these components.

The well 106 features a carefully engineered arrangement of components, with the lip 110 extending around the well opening to provide enhanced sealing capabilities. The wall 112 extends downward at an angle to guide samples toward the bottom 114, while the indicium 108 provides clear well identification for automated processing.

The structural elements are arranged to create a geometry that facilitates both sample collection and processing. The lip 110 is positioned to provide improved adhesion for sealing films, while the wall 112 maintains a precise angle designed to minimize sample adhesion. The bottom 114 incorporates a specialized geometry that promotes efficient heat transfer and sample recovery.

The well operates by providing a precisely controlled volume for sample containment while incorporating features that enhance sample collection, processing, and recovery. The lip 110 ensures reliable plate sealing, while the wall angle prevents sample adhesion during processing. The bottom geometry promotes efficient heat transfer during thermal cycling while maintaining compatibility with microscopic examination.

This detailed view illustrates geometric relationships that enable the plate’s enhanced performance capabilities. The precise dimensioning of these features enables direct microscopic examination of samples, efficient heat transfer during processing, and reliable sample recovery. The geometry described herein also supports automated sample collection while maintaining compatibility with standard laboratory equipment.

FIG. 5 illustrates a cross-sectional view of the well plate 100, taken along the line indicated in FIG. 2, showing the internal structure and dimensional relationships between components. The cross-section reveals the plate thickness 116, lip thickness 118, lip width 120, bottom width 122, and well width 124, demonstrating the geometric relationships that enable the plate’s enhanced functionality.

The components are arranged in a carefully engineered configuration that maintains precise dimensional relationships. The plate thickness 116 provides structural rigidity while supporting efficient heat transfer, while the lip thickness 118 and lip width 120 provide reliable sealing to a tape or film applied above. The bottom width 122 and well width 124 create an aspect ratio that facilitates sample handling and recovery.

The structural elements work together to create a unified assembly that maintains precise dimensional tolerances while incorporating specialized features for improved performance. The cross-sectional geometry demonstrates how the well dimensions narrow from top to bottom, creating a profile that guides samples toward the well bottom while minimizing adhesion to well walls.

The cross-sectional design operates by providing precise control over sample positioning and processing conditions. The well geometry described herein facilitates efficient sample collection and recovery, while the carefully controlled dimensions maintain compatibility with automated handling systems and microscopic examination capabilities.

This cross-sectional view reveals the dimensional relationships that enable the plate’s enhanced performance characteristics. The precise control of plate thickness supports efficient heat transfer during thermal cycling, while the well geometry facilitates sample collection and recovery. The lip dimensions ensure reliable plate sealing to tape or film applied to the top surface (104), while maintaining overall compatibility with standard laboratory equipment.

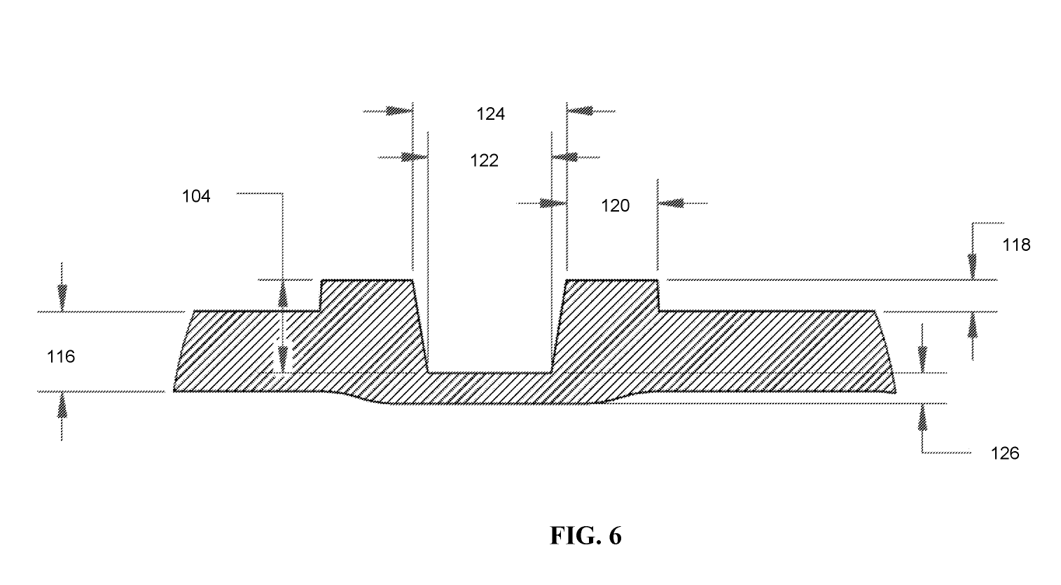

FIG. 6 provides a detailed cross-sectional view of a single well from the well plate, as indicated at section 6 of FIG. 5. The figure illustrates the precise dimensional relationships between the well width 124 and well bottom width 122, showing the geometry that enables enhanced sample handling capabilities.

The components are arranged in a tapered configuration, with the well width 124 at the opening gradually transitioning to the bottom width 122, creating an angled aspect ratio that accomplishes the objectives set out in more detail above. This geometric arrangement maintains the ability to conduct sample collection and testing with processing efficiency for small samples.

The structural elements work together to create a specialized well geometry that facilitates sample handling while preventing unwanted adhesion. The tapered wall configuration guides samples toward the well bottom while maintaining precise dimensional relationships that support microscopic examination and automated processing capabilities. The well geometry operates by providing controlled sample positioning and movement during collection and processing steps. The ratio between opening and bottom dimensions facilitates efficient sample collection during laser capture microdissection while promoting sample recovery during subsequent processing steps.

The plate thickness 116 is selected to provide structural rigidity while enabling efficient heat transfer, with the final design achieving a thickness that prevents warping during processing while maintaining thermal conductivity properties. The thickness was refined through multiple design iterations to achieve desired performance characteristics, balancing thickness (which provides structural strength) against thinness (which provides high heat transfer).

The lip height 118 provides enhanced sealing capabilities by creating a raised rim around each well that improves adhesion with sealing films while preventing cross-contamination between wells. This feature can provide reliable plate sealing during extended storage and processing periods. If the lip height 118 is too short, film or tape will not adhere fully or may interact with the surface 104 instead.

The lip width 120 works in conjunction with the lip height to create an effective sealing surface around each well, with dimension selected to maintain compatibility with standard sealing films while providing sufficient surface area for reliable adhesion.

The bottom diameter 122 is selected to create a reservoir in the well with the appropriate volume for proteomic sample preparation, and facilitates sample collection and recovery while promoting efficient heat transfer during thermal cycling.

The top diameter 124 provides a wider opening than a cylindrical well design would, and facilitates efficient sample collection during laser capture microdissection while maintaining precise dimensional control for automated handling compatibility.

The wall angle (3 degrees in the final design) creates a slight taper between the top and bottom diameters that helps prevent sample adhesion while maintaining manufacturability. This angle may also be chosen to facilitate ease of manufacturing, as too steep an angle is more difficult to fabricate.

The reinforced thickness area 126 under the well serves multiple functions in the plate design. During development, testing revealed that the center wells would deform without proper structural support, leading to variations in well depth that could impact sample collection and processing.

The reinforced bottom thickness area 126 resolves well depth variation issues while maintaining efficient heat transfer characteristics. This feature helps prevent deformation during injection molding and ensures uniform well depths across the plate, particularly in the center wells which were found to be more susceptible to depth variations during manufacture.

Without proper bottom reinforcement, the center wells may become deeper during common manufacturing techniques, such as injection molding, than edge wells. These differences in depth in turn could be responsible for creating inconsistencies in sample processing. The addition of reinforced thickness helped achieve consistent well depths while maintaining the plate’s thermal performance characteristics.

This structural element, reinforced bottom thickness area 126, works in conjunction with the plate’s overall thickness to provide enhanced rigidity while preserving heat transfer capabilities. The reinforced area 126 helps maintain precise dimensional control during manufacturing and use, ensuring reliable performance across all wells in the array.

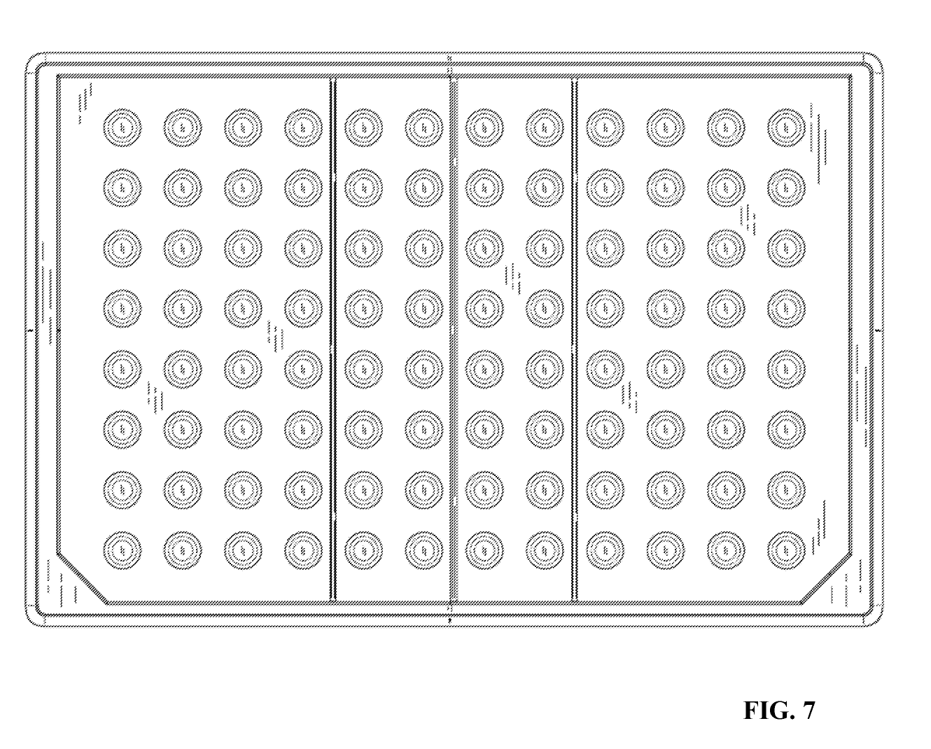

FIG. 7 illustrates a back view of an alternative embodiment of the well plate 100, showing a modified arrangement of structural features while maintaining the core functional capabilities of the design.

The back view reveals the arrangement of wells 106 in the standardized 12 × 8 array configuration, demonstrating how the alternative embodiment maintains compatibility with automated handling systems while incorporating modified structural features. The view particularly highlights the reinforced areas that provide enhanced structural stability.

The structural elements are arranged to provide a desired level of rigidity while preventing well depth variation, particularly in center wells which testing showed were more susceptible to deformation. The back view demonstrates how supporting structures are integrated into the design to maintain consistent well depths across the entire plate.

The alternative embodiment operates by providing enhanced structural support while maintaining the plate’s core functionality for sample collection and processing. The modified back structure helps prevent deformation during manufacturing and use, ensuring consistent performance across all wells in the array.

This alternative embodiment demonstrates how the basic design can be modified to enhance structural stability while maintaining compatibility with automated systems and preserving the specialized capabilities needed for small volume sample analysis. The modified structure helps ensure uniform well depths across the plate while maintaining efficient heat transfer characteristics and compatibility with standard laboratory equipment.

The standard embodiment shown in FIGS. 1-6 and the alternative embodiment in FIG. 7 share core functional capabilities while incorporating key structural differences in their design approaches. The primary structural difference lies in the back surface reinforcement strategy. The alternative embodiment incorporates additional supporting structures specifically designed to prevent well depth variation, particularly in center wells which testing showed were more susceptible to deformation. This modification was developed after testing revealed that center wells could become deeper than edge wells without proper structural support.

The alternative embodiment achieves uniform well depths through the addition of three supporting bars in the plate center, compared to the standard embodiment which relies on overall plate thickness for structural stability. These supporting bars were specifically added to resolve deformation issues identified during injection molding testing, providing enhanced structural support while maintaining thermal performance.

### EXAMPLE DIMENSIONS

The well plate incorporates precisely controlled dimensions that enable its enhanced performance characteristics. The plate maintains standardized overall dimensions of 127.48 ± 0.02 mm in length and 85.26 ± 0.02 mm in width, ensuring compatibility with conventional laboratory equipment while incorporating specialized features for improved sample handling.

The wells are arranged in a standardized 12 × 8 array configuration with precise well-to-well spacing of 8.98 ± 0.003 mm, maintaining tight dimensional tolerances for automated handling systems. Each well features a well opening diameter of 2.50 ± 0.01 mm that transitions to a bottom diameter of 2.00 ± 0.01 mm through a wall angle of 3 degrees, in one embodiment.

The plate incorporates a raised rim around each well with a height of 0.50 mm, providing enhanced sealing capabilities when used with adhesive films. The overall plate height measures 14.30 ± 0.10 mm, while maintaining a reduced well depth of 1.50 ± 0.05 mm that enables direct microscopic examination of samples.

The well geometry creates an effective working volume of 1-4 microliters, with a total well volume capacity of 5-6 microliters. This reduced volume, combined with the well geometry described above, helps prevent sample loss while maintaining efficient sample recovery.

It should be understood that in alternative embodiments, different dimensions could be used that still accomplish the objectives described herein. Furthermore, although the instant application describes use in the context of proteomics, there may be other applications where a small-well 96-well plate could provide advantages. While initially developed for spatial proteomics applications, the novel well plate design demonstrates utility across several additional biological and analytical applications. The plate’s ability to handle single-cell samples makes it particularly suitable for single-cell analysis applications beyond proteomics, as demonstrated through successful testing with individual cells.

The plate’s compatibility with multiple tissue preparation methods, including fresh frozen, OCT-embedded, and FFPE tissues, enables its use across diverse tissue analysis applications. This versatility has been validated through successful testing with various tissue types including human spleen tissue, human breast cancer tissue, mouse brain tissue, and human Alzheimer’s disease brain tissue samples.

The well plates designed for use with laser capture microdissection makes it valuable for any application requiring precise tissue sampling and analysis. The shallow well design, which enables direct microscopic examination, coupled with the plate’s compatibility with automated liquid handling systems and thermal cyclers, makes it suitable for high-throughput screening applications requiring small sample volumes.

The plate’s demonstrated ability to maintain sample integrity over extended periods, as validated through evaporation testing, suggests utility in applications requiring long-term sample storage or sequential analysis steps. Additionally, the polypropylene construction’s compatibility with DMSO and resistance to biomolecule binding makes the plate suitable for various chemical and biochemical assays requiring these characteristics.

The standardized dimensions and compatibility with existing laboratory automation equipment allow the plate to be integrated into various high-throughput workflows beyond proteomics. This includes potential applications in genomics, metabolomics, and other analytical techniques requiring precise handling of small volume samples while maintaining spatial information.

### Experimental Results

The novel well plate design demonstrates superior performance compared to conventional plates across several key experimental metrics. Testing showed the plate enables successful collection and analysis of tissue voxels as small as 20 × 20 × 10 micrometers (equivalent to single cells), while maintaining protein identification capabilities of up to 4,000 protein groups from 50 × 50 × 10 micrometer voxels (equivalent to 6 cells).

The plate’s shallow well design with 5-6 microliter total volume prevented sample loss. As demonstrated in testing, this represents a significant improvement over conventional 96-well plates that have total volumes of 200 microliters or 384-well plates with 40 microliter volumes, which result in unacceptable sample loss for proteomics analysis.

Evaporation testing validated the effectiveness of the plate’s sealing capabilities, with samples remaining stable over a 7-day period at room temperature when sealed with adhesive film. The well geometry of this example, featuring a 2.5 mm opening diameter narrowing to 2.0 mm at the bottom, combined with the polypropylene material, demonstrated minimal sample adhesion to well walls during collection and processing.

The plate enabled high-throughput collection capabilities, allowing automated collection of 96 tissue voxels in approximately 30 minutes, including verification steps. This represents a dramatic improvement over conventional methods that required nearly two weeks to collect 240 tissue voxels. The design proved compatible with multiple tissue types, including fresh frozen, OCT-embedded, and FFPE tissues.

In practical application, the plate successfully facilitated one of the largest reported laser capture microdissection-based proteome mapping studies, analyzing approximately 500 voxels from mouse brain tissue at 50 micrometer resolution (6-cell resolution). The plate maintained consistent performance across samples, with quality control showing a median of CV<15% (CV: coefficient of variation) and an average of approximately 2000 proteins across all these voxel samples with a CV of 45% for brain tissue samples.

What is claimed is:

1. A well plate comprising:
a base having a top surface;
an array of wells formed in the top surface;
each well having a lip extending around an opening of the well;
wherein the base includes areas of reinforced thickness beneath the wells; and
wherein the base has a plate thickness between 1.3-1.5 millimeters.

2. The well plate of claim 1, wherein the lip has a height of 0.5 millimeters.

3. The well plate of claim 1, wherein the lip has a width between 0.3-0.7 millimeters.

4. The well plate of claim 1, wherein the array comprises 96 wells arranged in a 12 × 8 configuration.

5. The well plate of claim 1, wherein adjacent wells are spaced 8.98 ± 0.003 millimeters apart.

6. The well plate of claim 1, wherein the base comprises polypropylene.

7. The well plate of claim 1, wherein the areas of reinforced thickness comprise supporting structures positioned between wells.

8. A well plate comprising:
a base having a top surface;
an array of wells formed in the top surface;
each well having:
a top opening with a first diameter;
a bottom with a second diameter smaller than the first diameter;
walls extending between the top opening and bottom at an angle; and
a depth of 1.5 ± 0.05 millimeters.

9. The well plate of claim 8, wherein the first diameter is 2.50 ± 0.01 millimeters.

10. The well plate of claim 8, wherein the second diameter is 2.00 ± 0.01 millimeters.

11. The well plate of claim 8, wherein the angle is 3 degrees.

12. The well plate of claim 8, wherein each well has a total volume between 5-6 microliters.

13. The well plate of claim 8, wherein each well has an effective working volume of 1-4 microliters.

14. The well plate of claim 8, wherein the array comprises 96 wells arranged with 8.98 ± 0.003 millimeter spacing between adjacent wells.

15. A method of making a well plate comprising:
forming a base having a top surface;
forming an array of wells in the top surface;
forming a lip around each well opening;
providing areas of reinforced thickness beneath the wells; and
maintaining a plate thickness between 1.3-1.5 millimeters.

16. The method of claim 15, wherein forming the array of wells comprises:
forming each well with a top opening having a first diameter;
forming each well with a bottom having a second diameter smaller than the first diameter; and
forming walls extending between the top opening and bottom at an angle.

17. The method of claim 16, wherein:
the first diameter is 2.50 ± 0.01 millimeters;
the second diameter is 2.00 ± 0.01 millimeters; and
the angle is 3 degrees.

18. The method of claim 15, wherein forming the lip comprises forming the lip to a height of 0.5 millimeters.

19. The method of claim 15, wherein providing areas of reinforced thickness comprises forming supporting structures between wells.

20. The method of claim 15, wherein forming the array comprises arranging 96 wells in a 12×8 configuration with 8.98 ± 0.003 millimeter spacing between adjacent wells.
